(19) United States
(12) Patent Application Publication
(10) Pub. No.: US 2026/0259128 A1
(43) Pub. Date: Sep. 3, 2026

(54) PARTICLE AND CELL SORTING THROUGHPUT ENHANCEMENT VIA PULSED LASERS

(71) Applicant: Astrin Biosciences, Inc., St. Paul, MN (US)

(72) Inventors: Anthony CLACKO, Eden Prairie, MN (US); Nathaniel BRISTOW, Excelsior, MN (US); Kaylee Judith KAMALANATHAN, Woodbury, MN (US); Nicholas HELLER, New Brighton, MN (US); Jayant PARTHASARATHY, Excelsior, MN (US); Jiarong HONG, Eden Prairie, MN (US)

(73) Assignee: Astrin Biosciences, Inc., St. Paul, MN (US)

(21) Appl. No.: 19/163,170

(22) PCT Filed: Mar. 8, 2024
(86) PCT No.: PCT/US2024/019064

§ 371 Date: Sep. 8, 2025

Related U.S. Application Data
(60) Provisional application No. 63/489,109, filed on Mar. 8, 2023.

(51) Int. Cl. G01N 15/149; G01N 15/01; G01N 15/10; G01N 15/14; G01N 15/1433; G01N 15/1434

(52) U.S. Cl. CPC G01N 15/149; G01N 15/01; G01N 15/1427; G01N 15/1433; G01N 15/147; G01N 2015/1027; G01N 2015/144; G01N 2015/1454

(57) ABSTRACT

The present embodiments relate to an optical system design that aims to enhance the throughput of imaging-based particle sorting systems without requiring the need for multiple sequential camera exposures to determine the speed of particles as they pass through the field of view. The system as described herein can use either one chromatic digital camera or two synchronized digital cameras (either monochromatic or chromatic) and two pulsed lasers at different wavelengths. The system can capture images of particles flowing in a stream such that each exposure is illuminated by one or two pulses of laser light from light sources to determine each identified target particle's speed in the stream. The information collected from the system can be used to control the actuation and timing of actuation of a particle sorting device downstream of the image sample region.

### PRIORITY

This application claims the benefit of U.S. Ser. No. 63/489,109, filed on Mar. 8, 2023, which is incorporated by reference herein in its entirety.

### TECHNICAL FIELD

The methods and compositions described here relate to the field of particle and cell sorting systems. More particularly, embodiments relate to an optical system that aims to enhance the throughput of an imaging-based particle and cell sorting system and methods of using the systems.

### BACKGROUND

A plurality of particles or cells of varying particle or cell types can be part of a biological fluid, such as a stream of blood cells. For any of a variety of reasons, isolating cells of a specific type from the biological fluid may be desired. For example, cells such as cancer cells (e.g., circulating tumor cells (CTCs)) or immune cells can be separated from a blood stream or other fluid sample for further analysis. A microfluidic device can implement any of a variety of techniques to isolate particles or cells by characteristics specific to each particle or cell type, such as particle or cell size, flow rate, etc.

In many cases, cell sorting systems can implement computer technologies to selectively sort cells in a microfluidic device. With advancements being made in both computing (e.g., graphical processing unit (GPU) technologies) and machine learning algorithms, image-based cell sorting has gained significant momentum. Improved cell sorting methods based on computing, machine learning, and imaging are needed in the art.

### SUMMARY

The present embodiments relate to an optical system design that aims to enhance the throughput of an imaging-based particle or cell sorting system by both identifying particles or cells to target for isolation and determining the speed at which those particles or cells are traveling from only one exposure of a digital chromatic camera or one synchronized exposure from each of two digital cameras (either chromatic or monochromatic). In a two-camera system, one camera can continuously record images of particles or cells in a stream where each exposure is illuminated by a single pulse of laser light at a specific wavelength. A computational analysis of these images can be performed to determine whether any of the images contain particles or cells to target for isolation. The second camera can record images of the same stream of particles or cells where each exposure, synchronized with the first camera, is illuminated by a double pulse of laser light at a wavelength different from the wavelength of the single laser pulse. These double-pulsed images can be computationally analyzed to determine the speed that the target particles or cells identified in images from the first camera are traveling. In a single chromatic camera system, each individual exposure can be illuminated by both the single and double laser pulses as described above. Computational analysis of these images attuned to the different colors generated by the single and double laser pulses can enable target particle or cell detection and calculation of target particle or cell speed.

An aspect provides an optical system comprising a first light source configured to emit light of a first wavelength according to a first pulsing pattern; a second light source configured to emit light of a second wavelength according to a second pulsing pattern; a microfluidic device configured to transport and isolate a single particle in a fluid; a first camera configured to capture a first image of the single particle in the microfluidic device, wherein the first image is illuminated by the light of the first wavelength emitted by the first light source; and a second camera configured to capture a second image of the single particle in the microfluidic device, wherein the second image is illuminated by the light of the second wavelength emitted by the second light source.

The first pulsing pattern can comprise a single pulse of light of the first wavelength for each exposure duration, and the second pulsing pattern can comprise two pulses of light of the second wavelength for each exposure duration. A first pulse can be pulsed prior to the single pulse of light for the first pulsing pattern and a second pulse after the single pulse of light for the first pulsing pattern. The two pulses of light of the second pulsing pattern can occur prior to the single pulse of the first pulsing pattern. The two pulses of light of the second pulsing pattern can occur after the single pulse of the first pulsing pattern. A first pulse of the second pulsing pattern can occur prior to the single pulse of the first pulsing pattern. A first pulse of the second pulsing pattern can occur after the single pulse of the first pulsing pattern. The first image can comprise a single exposed image of the single particle and the second image can comprise a double pulsed image of the single particle. An optical system can further comprise a first filter disposed in front of a lens of the first camera, the first filter configured to filter out the light of the second wavelength; and a second filter disposed in front of a lens of the second camera, the second filter configured to filter out the light of the first wavelength. The microfluidic device can comprise a channel configured to transport the fluid, with a first outlet for isolating single particles of a target particle type and a second outlet for outputting any remaining portion of particles in the fluid. An optical system can further comprise a computing node comprising a memory and a processor, the memory comprising instructions that, when executed by the processor, cause the processor to provide, for each of a series of exposures, an exposure time and an exposure duration for each of the first camera and the second camera; and cause the first light source and the second light source to emit light according to each of the first pulsing pattern and the second pulsing pattern for each exposure. The instructions can further cause the processor to obtain the first image from the first camera and the second image from the second camera; and processing the first image and the second image to determine whether the single particle is of a target particle type, and a speed of the single particle traveling in the microfluidic device based on a distance of the single particle as depicted in each of two pulses of light of the second wavelength from the second camera according to a timing of the second pulsing pattern. The first light source and the second light source can be disposed below the microfluidic device, and the first camera and the second camera can be disposed above the microfluidic device. The microfluidic device can be a sawtooth inertial sorting microfluidic device. The speed at which a particle is moving can be determined from only one synchronized exposure of the first and second cameras.

Another aspect provides a method comprising transmitting a first message to each of a first camera and a second camera, the first message comprising, for each exposure, an exposure start time and exposure duration to capture images of a single particle in a microfluidic device; transmitting a second message to each of a first light source and a second light source to cause the first light source to emit light of a first wavelength according to a first pulsing pattern and the second light source to emit light of a second wavelength according to a second pulsing pattern; obtaining a first image from the first camera and a second image from the second camera; and processing the first image and the second image to determine whether the single particle is of a target particle type, and a speed of the single particle traveling in the microfluidic device based on a distance of the single particle as depicted in each of two pulses of light of the second wavelength from the second light source according to the second pulsing pattern.

The first pulsing pattern can comprise a single pulse of light of the first wavelength for each exposure duration, and the second pulsing pattern can comprise two pulses of light of the first wavelength for each exposure duration, with a first pulse prior to the single pulse of light for the first pulsing pattern and a second pulse after the single pulse of light for the first pulsing pattern. The first image can comprise a single exposed image of the single particle and the second image can comprise a double pulsed image of the single particle. The microfluidic device can comprise a channel configured to transport a fluid, with a first outlet for isolating particles of a target particle type and a second outlet for outputting any remaining portion of particles in the fluid. The microfluidic device can be a sawtooth inertial sorting microfluidic device. The speed at which the particle is moving can be determined from only one synchronized exposure of the first and second cameras.

Even another aspect provides a system comprising a first camera configured to capture a first image of a single particle in a population of particles in a microfluidic device; a first light source configured to emit at least one light of a first wavelength according to a first pulsing pattern including at least a first pulse and a second pulse with a timing spaced out such that the single particle is able to be identified and a velocity of the single particle is able to be derived; and a microfluidic device comprising a channel transporting a fluid containing the single particle. The first pulsing pattern can include two pulses of light for each exposure of the first camera. The first light source can be a multi-spectral light source configured to emit light of the first wavelength according to the first pulsing pattern and emit light of a second wavelength according to a second pulsing pattern. The system can further comprise a second light source configured to emit light of a second wavelength according to a second pulsing pattern. The first pulsing pattern can comprise a single pulse of light of the first wavelength for each exposure duration, and the second pulsing pattern can comprise two pulses of light of the first wavelength for each exposure duration, with a first pulse prior to the single pulse of light for the first pulsing pattern and a second pulse after the single pulse of light for the first pulsing pattern. The first camera can be a monochromatic camera or a chromatic camera. The system can further comprise a second camera configured to capture a double pulsed image of the single particle. The speed at which the particle is moving can be determined from only one synchronized exposure of the first and second cameras. The first and second cameras can be chromatic cameras. The system can further comprise a first filter disposed in front of a lens of the first camera, the first filter configured to filter out the light of a second wavelength; and a second filter disposed in front of a lens of the second camera, the second filter configured to filter out the light of the first wavelength. The system can further comprise a computing node comprising a memory and a processor, the memory comprising instructions that, when executed by the processor, cause the processor to synchronize, for each of a series of exposures, an exposure time and an exposure duration for the first camera; and cause the first light source to emit light according to the first pulsing pattern for each exposure. obtain the image from the first camera; and process the first image a speed of the single particle traveling in the microfluidic device based on a distance of the single particle as depicted in the first image. The microfluidic device can be a sawtooth inertial sorting microfluidic device.

Another aspect provides a method of identifying and/or sorting particles comprising delivering a fluid sample comprising the particles to the microfluidic device of an optical system comprising a first light source configured to emit light of a first wavelength according to a first pulsing pattern; a second light source configured to emit light of a second wavelength according to a second pulsing pattern; a microfluidic device configured to transport and isolate a single particle in a fluid; a first camera configured to capture a first image of the single particle in the microfluidic device, wherein the first image is illuminated by the light of the first wavelength emitted by the first light source; and a second camera configured to capture a second image of the single particle in the microfluidic device, wherein the second image is illuminated by the light of the second wavelength emitted by the second light source. A first image can be transmitted to each of the first camera and the second camera, the first message comprising, for each exposure, an exposure start time and exposure duration to capture images of a single particle in the microfluidic device. A second message can be transmitted to each of the first light source and the second light source to cause the first light source to emit light of a first wavelength according to a first pulsing pattern and the second light source to emit light of a second wavelength according to a second pulsing pattern. A first image can be obtained from the first camera and a second image from the second camera. The first and second image can be processed to determine whether the single particle is of a target particle type, and a speed of the single particle traveling in the microfluidic device based on a distance of the single particle as depicted in each of two pulses of light of the second wavelength from the second light source according to the second pulsing pattern. The target particle can be a cell, such as a cancerous cell or an immune cell. The microfluidic device can comprise a first outlet for sorting the target particle and a second outlet for outputting non-target particles.

Yet another aspect provides a method of identifying and/or sorting particles comprising delivering a fluid sample comprising the particles to the microfluidic device of an optical system comprising a first camera configured to capture a first image of a single particle in a population of particles in a microfluidic device and a second camera configured to capture a double pulsed image of the single particle, a first light source configured to emit at least one light of a first wavelength according to a first pulsing pattern including at least a first pulse and a second pulse with a timing spaced out such that the single particle is able to be identified and a velocity of the single particle is able to be derived; and a microfluidic device comprising a channel transporting a fluid containing the single particle. A first message is transmitted to each of the first camera and the second camera, the first message comprising, for each exposure, an exposure start time and exposure duration to capture images of a single particle in the microfluidic device. A second message is transmitted to the first light source to cause the first light source to emit light of a first wavelength according to a first pulsing pattern and the first light source to emit light of a second wavelength according to a second pulsing pattern. A first image is obtained from the first camera and a second image from the second camera. The first image and the second image are processed to determine whether the single particle is of a target particle type, and a speed of the single particle traveling in the microfluidic device based on a distance of the single particle as depicted in each of two pulses of light of the second wavelength from the second light source according to the second pulsing pattern. The first light source can be a multispectral fiber laser operating in pulse mode. The target particle can be a cell such as a cancer cell or an immune cell. The microfluidic device can comprise a first outlet for sorting the target particle and a second outlet for outputting non-target particles.

Another aspect provides a method of identifying and/or sorting particles comprising delivering a fluid sample comprising the particles to the microfluidic device of an optical system comprising a first camera configured to capture a first image of a single particle in a population of particles in a microfluidic device; a first light source configured to emit at least one light of a first wavelength according to a first pulsing pattern including at least a first pulse and a second pulse with a timing spaced out such that the single particle is able to be identified and a velocity of the single particle is able to be derived; and a microfluidic device comprising a channel transporting a fluid containing the single particle. A first message can be transmitted to the first camera, the first message comprising, for each exposure, an exposure start time and exposure duration to capture images of a single particle in the microfluidic device. A second message can be transmitted to the first light source to cause the first light source to emit light of a first wavelength according to a first pulsing pattern and the first light source to emit light of a second wavelength according to a second pulsing pattern. A first image and a second images can be obtained from the first camera. The first image and the second image can be processed to determine whether the single particle is of a target particle type, and a speed of the single particle traveling in the microfluidic device based on a distance of the single particle as depicted in each of two pulses of light of the second wavelength from the second light source according to the second pulsing pattern. The first camera can be a chromatic camera or a monochromatic camera. The first light source can be a multispectral fiber laser operating in pulse mode. The first light source can be a single wavelength or multispectral pulse laser. The target particle can be a cell such as a cancerous cell or an immune cell. The microfluidic device can comprise a first outlet for sorting the target particle and a second outlet for outputting non-target particles.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is an illustration of an example system including microfluidic channel 102 transporting a plurality of particles or cells according to an embodiment.

FIG. 2 is an illustration an example pattern of light pulses from the two lasers with different wavelengths according to an embodiment.

FIG. 3 illustrates an example system for producing images of particles or cells using light from lasers with different wavelengths to measure the speed with which a particle or cell of interest is traversing a microfluidic device according to an embodiment.

FIG. 4 is an illustration of an example system producing images of particles or cells using light from a multispectral fiber laser pulsing in two wavelengths to measure the speed with which a particle or cell of interest is traversing a microfluidic device according to an embodiment.

FIG. 5 is an example system producing chromatic images of cells using light from a multispectral fiber laser pulsing in two wavelengths to measure the speed with which a cell of interest is traversing a microfluidic device according to an embodiment.

FIGS. 6A-6C illustrate views of an example of a pulsed laser digital inline holographic imaging system for particle or cell sorting.

FIG. 7 is an example double-exposed holographic image showing three cells making small displacement during the time interval between the two exposures according to an embodiment.

FIG. 8 provides an example method for implementing an optical system managing a throughput of an imaging-based particle or cell sorting system according to an embodiment.

FIG. 9 is a block diagram of a special-purpose computer system according to an embodiment.

### DETAILED DESCRIPTION

Various particles or cells of different types can be part of a fluid, such as a biological fluid like a stream of blood cells. It can be desirable to separate particles or cells of a specific type from a fluid, such as a biological fluid. Particles can include prokaryotic cells, eukaryotic cells, bacteria, viruses, beads, small molecules, organelles, proteins, etc. Cells can include different cell types such as cancerous cells, healthy cells, immune cells, labeled cells, unlabeled cells, white blood cells, red blood cells, etc. For example, cancer cells (or circulating tumor cells (CTCs)) can be separated from a blood stream for further analysis. A microfluidic device can implement any of a variety of techniques to isolate cells by parameters specific to each particle or cell type, such as particle or cell size, flow rate, etc.

In many cases, particle and cell sorting systems can implement computer technologies to selectively sort particles or cells in a microfluidic device. With advancements being made in both computing (e.g., graphical processing unit (GPU) technologies) and machine learning algorithms, image-based cell sorting has gained significant momentum in comparison to other particle or cell sorting approaches (e.g., approaches based on inertial, mechanical, acoustic, electric, and dielectric properties of particles or cells).

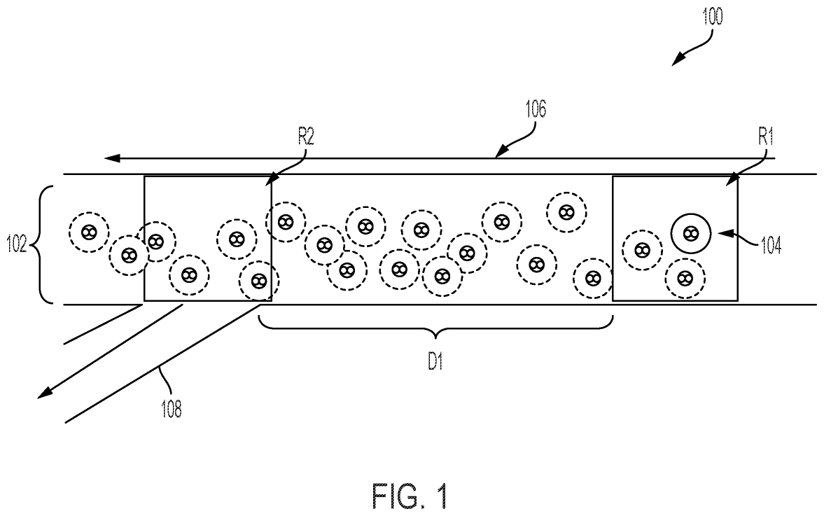

FIG. 1 is an illustration of an example system 100 including microfluidic channel 102 transporting a plurality of particles or cells. For example, as illustrated in FIG. 1, in image-based particle or cell sorting, an interrogation region (e.g., a region where the images of particles or cells are recorded) can generally be located upstream of the particle or cell sorting region in a microfluidic channel. A time delay between the detection of targeted particles or cells and the actuation of sorting can be precisely determined to ensure the sorting accuracy. Such a delay can typically be determined using the distance between the location of detected particles or cells and that of a particle or cell sorting region divided by the particle or cell traveling speed.

For instance, as shown in FIG. 1, a microfluidic channel 102 can comprise a channel of a microfluidic device designed to isolate or separate particles by one or more particle or cell parameters. Among a plurality of particles or cells, each particle or cell can have a specific particle or cell type. For example, a cell of interest 104 can comprise a cancer cell type or an immune cell type.

The channel 102 can include a region defining the frame of an image, represented as R1. The channel 102 can further include a region where particle or cell isolation can occur, which is represented as R2. Furthermore, a flow direction of the particles or cells 106 can flow from R1 to R2, and a distance between the regions R1 and R2 can be represented by D1. D1 is the fixed distance between the region where imaging takes place and the region where cell isolation can occur. The channel 102 can also include a channel for particles or cells of interest 108 that have been isolated from the stream. For example, the channel 108 can isolate a particle or cell of interest 104 from the stream of particles or cells in the microfluidic channel 102.

A speed of particles or cells traveling through the microfluidic channel can impact the capturing of images of the particles or cells. To determine the particle or cell travelling speed, an imaging system can comprise one or more cameras that can take multiple exposures of the same particle or cell. For a camera with fixed maximum frame rate, this can mean that the microfluidics may need to flow particles or cells slower to enable the capture of their speeds, which can reduce the throughput of the particle or cell sorting system. Therefore, it is desirable to allow the measurement of particle(s) or cell(s) traveling at a speed with one exposure that can effectively enhance the throughput of particle or cell sorting.

The present embodiments relate to optical system designs that aim to enhance the throughput of imaging-based particle or cell sorting systems. The systems as described herein can use one or more (e.g., two, three, four, or more) synchronized digital cameras and two or more (e.g., 2, 3, 4, or more) wavelength pulsed lasers, with one camera capturing a double-exposed image of a targeted particle or cell for determining its speed, and another camera recording the single-exposed image of the particle or cell using a laser of different wavelength. The information collected from the systems can be used to control the actuation and timing of actuation of the particle or cell sorting device downstream of the image sample region. Particularly, the systems as described herein can determine the speed at which any particle or cell of interest is moving through the channel from only one synchronized exposure of the cameras. A synchronized exposure can mean the two exposures are timed such that each exposure is separated by a short time interval (e.g., about 4 μs to 100 ms (e.g., about 4, 10, 50, 100, 500, 1,000 μs or more or 1, 10, 20, 30, 40, 50, 60, 70, 80, 90, 100 ms or more or any range between about 4 μs and about 100 ms). That is, the two cameras are synchronized, but the first and second exposures can occur sequentially.

In some aspects, a system can include two or more cameras that can capture image(s) of particles or cells flowing through a single common region of a microfluidic channel. The two or more cameras can capture a continuous stream of images. Furthermore, the capturing of common images from each camera can be synchronized to have the same exposure start time and duration. The time each image is captured can be recorded.

A first camera can capture images of particles or cells illuminated by a laser with a specific wavelength that is pulsed on and off one time or more (e.g., 1, 2, 3, 4 or more times) during the exposure period. These images can be computationally analyzed to identify particles or cells of interest. A second camera can take images illuminated by a second laser with a wavelength different from the wavelength of the first laser. A second laser can be pulsed on and off twice (or 3, 4, 5, or more times) during the exposure period resulting in a double (or multiple) pulsed image. A single pulse of light generated by the first laser can occur between the pulses of light generated by the second laser.

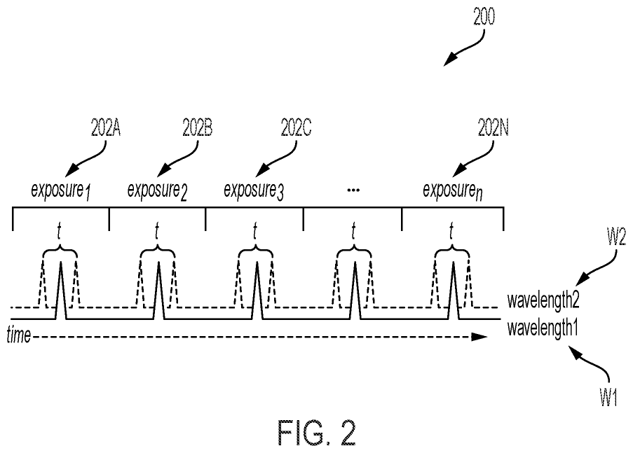

FIG. 2 is an illustration 200 an example pattern of light pulses from the two lasers with different wavelengths. As shown in FIG. 2, a first series of light pulses of a first wavelength W1 and a second series of light pulses W2 can be shown with respect to time. The cameras can be synchronized to begin exposure at the same time and for a same or similar duration.

For example, the cameras can have a synchronized exposure at each exposure duration 202A-N(e.g., a duration between 4 μs to 100 ms (e.g., about 4, 10, 50, 100, 500, 1,000 μs or more or 1, 10, 20, 30, 40, 50, 60, 70, 80, 90, 100 ms or more or any range between about 4 μs and about 100 ms). During each exposure, each laser can pulse, with a first laser pulsing once and a second laser pulsing twice. The double pulsing of the second laser (e.g., of wavelength W2) can bracket the pulse from the first laser (e.g., of wavelength W1).

In another aspect, the cameras can have synchronized exposure where the two exposures are timed such that each exposure is separated by a short time interval (e.g., about 4 μs to 100 ms (e.g., about 4, 10, 50, 100, 500, 1,000 μs or more or 1, 10, 20, 30, 40, 50, 60, 70, 80, 90, 100 ms or more or any range between about 4 us and about 100 ms). That is, the two cameras are synchronized, but the first and second exposures can occur sequentially.

### Microfluidic Devices

A microfluidic device represents a microfluidic channel plus all of its relevant micro-features such as inlet and outlet ports. A microfluidic chip is the physical platform that houses the microfluidic device. The chip can house multiple microfluidic devices. A microfluidic device can be any suitable microfluidic device, e.g., a straight channel microfluidic device, a Y-channel microfluidic device, a T-junction microfluidic device, a cross-junction microfluidic device, a spiral microfluidic device, a micro-mixing device, a micro-reactor device, a microfluidic device for separation, merging micro-channel device, splitting microfluidic devices. In certain aspects, microfluidic devices and/or microfluidic channels are made of a transparent material so that particles and biological materials, e.g., cells, moving through the channels can be imaged/sensed. The methods and systems described herein can be used to image/sense stationary samples or flowing, moving, or traveling samples that are present in a fluid and moving through, e.g., a microfluidic device or other suitable device.

In an aspect, a microfluidic device is a sawtooth inertial sorting microfluidic device as described in PCT/US23/74932, filed on Sep. 22, 2023, which is incorporated by reference herein in its entirety. A sawtooth inertial sorting microfluidic device can comprise an inlet for receiving particles of varying sizes across varying flow rates. The particle separation device can also include a main channel comprising a first end and a second end. The first end can be connected to the inlet. The main channel can comprise a series of angled portions. Each of the angled portions can form an angle that can be acute or obtuse (e.g., comprising angles between 1-89 degrees, or between 91 and 179 degrees) relative to an adjacent angled portion. The main channel can be configured to provide an inertial separation of the particles received at the inlet. The series of angled portions can reduce a pressure in the particle separation device and control varying flow rates of particles received at the inlet.

The sawtooth inertial sorting microfluidic device can also include one or more outlets connected to a second end of the main channel. Each of the one or more outlets can be configured to receive separated particles of differing sizes and/or densities.

In some instances, at least a portion of edges connecting each of the series of angled portions with the adjacent angled portion are rounded.

In some instances, the sawtooth inertial sorting microfluidic device can include between three and five outlets.

In some instances, the main channel comprises: a first stage and a second stage, wherein both the first stage and the second stage of the main channel are directly connected to at least one of the outlets.

In some instances, a second channel is disposed between the first stage and the second stage of the main channel, the second channel connecting to a first outlet.

In some instances, a second channel is disposed between the first stage and the second stage of the main channel, the second channel including two open ends, with each open end connecting to corresponding outlets.

In some instances, the sawtooth inertial sorting microfluidic device comprises a height of 50 micrometers and a width of between 100-200 micrometers.

In some instances, the sawtooth inertial sorting microfluidic device is configured to operate in a laminar flow regime and a transitional flow regime.

In some instances, the sawtooth inertial sorting microfluidic device includes a Reynolds number that is less than or equal to 2000 (e.g., less than about 2,000, 1,750, 1,500, 1,250, 1,000, 750, 500, or 250).

In some instances, the one or more outlets are either disposed in-line with the main channel or are disposed offset relative to a direction of the main channel. In an aspect an outlet is offset from a main channel by about 20, 30, 45, 50, 60, 70, 80, 90, 100, 120, 130, 140, 150, 160, 170, or 175 degrees, but any amount of offset is contemplated.

In another example embodiment, a sawtooth inertial sorting microfluidic system for separating particles or cells of varying sizes and/or inertia across varying flow rates using inertial separation is provided. The system can include an inlet and a main channel connected to the inlet at a first end of the main channel. The main channel can include a series of angled portions. Each of the angled portions can form an angle that is greater than 90 degrees to an adjacent angled portion The system can also include a set of outlets connected to a second end of the main channel.

In some instances, at least two of the series of angled portions including angles that are either less than or greater than 90 degrees form a trapezoidal corner.

In some instances, a first portion of the series of angled portions form trapezoidal corners and a second portion of the series of angled portions include rounded edges.

In some instances, at least one edge connecting each of the series of angled portions with adjacent angled portions is rounded. The angled portions can be trapezoidal wave shaped or sawtooth wave shaped. The angled portions can have a wavelength of 0.1 mm to 5 mm. The main channel can have a width of 50 to 600 micrometers and a depth of 30 to 70 μm.

In another example, a sawtooth inertial sorting microfluidic device can include an inlet for receiving particles of varying sizes across varying flow rates. The device can also include a main channel comprising a first stage and a second stage, with a first end of the first stage of the main channel connected to the inlet. The main channel can include a series of angled portions. The main channel can be configured to provide an inertial separation of the particles received at the inlet. The device can also include at least two outlets, with at least a first outlet connected to the first stage of the main channel and a second outlet connected to the second stage of the main channel.

In some instances, each of the angled portions forming an angle with an adjacent angled portion that is either less than or greater than 90 degrees.

In some instances, the first stage comprises angled portions forming angles less than 45 degrees and the second stage comprises angled portions that are greater than 90 degrees forming trapezoidal corners.

In some instances, any of the first stage or second stage comprises angled portions forming angles less than 45 degrees that form trapezoidal corners. The angled portions can be trapezoidal wave shaped or sawtooth wave shaped. The angled portions can have a wavelength of 0.1 mm to 5 mm. The main channel can have a width of 50 to 600 micrometers and a depth of 30 to 70 μm.

An aspect provides a sawtooth inertial sorting microfluidic device comprising an inlet for receiving particles of varying sizes and/or differing inertia across varying flow rates; a main channel comprising a first stage and a second stage, the first stage comprising a first end connected to the inlet and a second end connected to the second stage, the second stage comprising 2, 3, 4, 5, or more channels each connected to one or more outlets, wherein the first stage comprises a channel comprising a series of angled portions, with each of the angled portions forming an angle of either less than or greater than 90 degrees to an adjacent angled portion, where the angle formed in the first stage channel is configured to provide an inertial separation of the particles, wherein the channels of the second stage comprise a series of angled portions, with each of the angled portions forming an angle of either less than or greater than 90 degrees to an adjacent angled portion, where the angle formed in the second stage channels is configured to provide an inertial separation of the particles, wherein each of the one or more outlets is configured to receive separated particles of differing sizes and/or differing inertia. The series of angled portions of the first stage channel can be different from the series of angled portions of the second stage channels. The series of angled portions of the first stage channel can be trapezoidal wave shaped, and the series of angled portion of the second stage channels can be sawtooth wave shaped. The series of angled portions of the first stage channel can be sawtooth wave shaped, and the series of angled portion of the second stage channels can be trapezoidal wave shaped. The angled portions can have a wavelength of 0.1 mm to 5 mm.

Another aspect provides a sawtooth inertial sorting microfluidic device comprising an inlet for receiving particles of varying sizes and/or differing inertia across varying flow rates; a main channel comprising a first stage, a second stage, and a third stage. The first stage can comprise a first end connected to the inlet and a second end connected to the second stage, the second stage comprising 2, 3, 4, 5, or more channels each connected to one or more outlets and one channel connected to the third stage. The third stage can comprise 2, 3, 4, 5, or more channels each connected to one or more outlets, the first stage can further comprise a channel comprising a series of angled portions, with each of the angled portions forming an angle of either less than or greater than 90 degrees to an adjacent angled portion, where the angle formed in the first stage channel is configured to provide an inertial separation of the particles. The channels of the second stage can comprise a series of angled portions, with each of the angled portions forming an angle of either less than or greater than 90 degrees to an adjacent angled portion, where the angle formed in the second stage channels is configured to provide an inertial separation of the particles. The channels of the third stage can comprise a series of angled portions, with each of the angled portions forming an angle of either less than or greater than 90 degrees to an adjacent angled portion, where the angle formed in the third stage channels is configured to provide an inertial separation of the particles, wherein each of the one or more outlets is configured to receive separated particles of differing sizes and/or differing inertia.

The series of angled portions of the first stage channel can be trapezoidal wave shaped or sawtooth wave shaped, the series of angled portions of the second stage channels can be trapezoidal wave shaped or sawtooth wave shaped, and the series of angled portions of the third stage channels can be trapezoidal or sawtooth wave shaped. The angled portions can have a wavelength of 0.1 mm to 5 mm.

As described in greater detail below, the implementation of the present system(s) can be achieved using, e.g., several optical designs described below (and combinations thereof) depending on the particle or cell sample properties.

For instance, in a first example design, an optical system can include two synchronized cameras, with each camera configured to capture an image of a particle or cell illuminated via light of a different wavelength. The light of each wavelength can be pulsed by each of two laser light sources.

A second example design can include two synchronized cameras and a single multispectral fiber laser operating in pulse mode. The multispectral fiber laser can pulse light of different wavelengths as described herein.

A third example design can include a single chromatic camera and a multispectral fiber laser operating in pulse mode. The chromatic camera can be configured to capture an image of a particle or cell illuminated by the different wavelengths as pulsed by the multispectral fiber laser.

In a fourth example design, a system can include one single wavelength pulse laser or a multispectral pulse laser and a monochromatic camera. The single wavelength or a multispectral pulse laser can provide a pulse (or two pulses) for each exposure of the monochromatic camera to capture the image of the particle or cell of interest in the microfluidic device channel. The fourth design can be used in instances where the particle or cell concentration in the microfluidic device is relatively low.

The elements of each design, e.g., one or more chromatic cameras, one or more monochromatic cameras, one or more synchronized cameras, one or more laser light sources, one or more multispectral fiber lasers operating in pulse mode, one or more microfluidic devices, one or more beam splitters, one or more mirrors, one or more computing nodes, one or more objectives, one or more filters, can be added or subtracted from each design to arrive at a combination design.

In some aspects, a system can comprise 1, 2, 3, 4, or more cameras (e.g., monochromatic camera, synchronized cameras, chromatic cameras), 1, 2, 3, 4, or more lasers (e.g., single wavelength pulse laser, or a multispectral pulse laser, multispectral fiber laser operating in pulse mode), one or more beam splitters, one or more objectives, one or more mirrors, one or more computing nodes, and/or one or more filters.

### Example Design 1

A first example design of a system to enhance the throughput of the current imaging-based particle or cell sorting system can include a system with two or more lasers and two or more cameras. Each laser can be configured to pulse light of a specific wavelength (e.g., 350, 400, 500, 600, 700, 800 nm or any value between 350 and 800 nm). Furthermore, two or more cameras can be synchronized to have a synchronized exposure start time and duration of exposure. For example, laser 314 can emit the pulses of light at the first wavelength (e.g., one pulse per exposure) and the second wavelength (e.g., two pulses per exposure) as described herein. In an aspect, the cameras can have synchronized exposure where the two exposures are timed such that each exposure is separated by a short time interval (e.g., about 4 μs to 100 ms (e.g., about 4, 10, 50, 100, 500, 1,000 μs or more or 1, 10, 20, 30, 40, 50, 60, 70, 80, 90, 100 ms or more or any range between about 4 μs and about 100 ms). That is, the two cameras are synchronized, but the first and second exposures can occur sequentially. In another aspect, the first and second exposures occur at the same time.

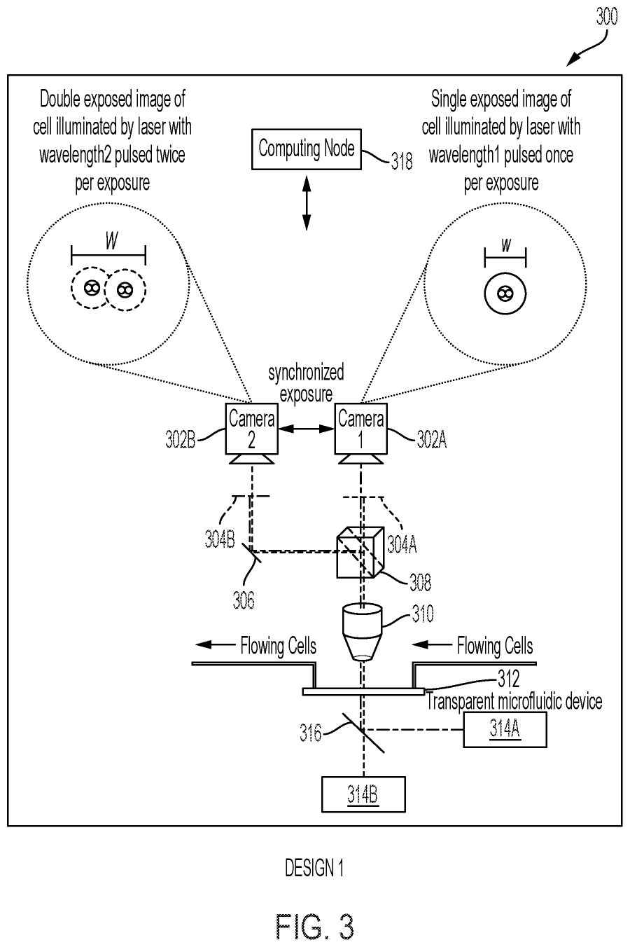

FIG. 3 illustrates an example system 300 for producing images of particles or cells using light from lasers with different wavelengths to measure the speed with which a particle or cell of interest is traversing a microfluidic device. As shown in FIG. 3, a first camera 302A and a second camera 302B can have a synchronized exposure start and duration. The first camera 302A can capture a single-exposed image of a particle or cell illuminated by the first laser 314A pulsing a first wavelength W1 once per exposure. The second camera 302B can capture a double pulsed image of the particle or cell illuminated by the second laser 314B pulsing the second wavelength W2 twice per exposure.

The system 300 can also include filter 304A-B disposed in front of a lens of each camera 302A-B. For instance, a first filter 304A can filter to remove light from the second laser 314B of the second wavelength. Similarly, the second filter 304B can filter to remove light from the first laser 314A of the first wavelength. The filters 304A-B can filter out light to prevent interference of light captured at each camera 302A-B.

In some instances, the light can be reflected (in some instances, by a mirror 306) and split via a beam splitter 308. The light can further be directed through an objective 310 onto a transparent microfluidic device 312 that transports flowing particles or cells. A beam splitter or dichroic mirror 316 can be disposed between lasers 314A-B and can direct laser light through the transparent microfluidic device 312. While the cameras 302A-B can be disposed above the device 312, and the lasers 314A-B are disposed below the device 312, any component can be disposed either above or below the device 312 with associated optical components (e.g., mirrors, beam splitters, etc.).

An optical system can include a beam splitter, common objective, beam splitter, and a mirror, which can ensure that the images captured by each camera are of the identical region of the microfluidic device. An optical filter tuned to the wavelength of the first laser can be used to ensure the light generated by the first laser is not captured in the image produced by the second camera. Likewise, an optical filter tuned to the wavelength of the second laser can be used to ensure the light generated by the second laser is not captured in the image produced by the first camera.

The relative position of a particle or cell of interest identified within the frame of an image captured by the first camera can be used to identify the corresponding double pulsed particle or cell of interest captured by the second camera. The distance the particle or cell traveled during the interval between pulses of the second laser can be calculated from the width of the blurred image of the double pulsed particle or cell less the width of the image of the single exposed particle or cell. Dividing this distance by the time interval between pulses of the second laser can provide the speed the particle or cell is traveling.

The speed of cell can be calculated by:

$$\frac{W - w}{t}$$

Where t is the rate between pulses of laser wavelength W1.

Alternatively, in any frame in which a particle or cell of interest is identified, the speed at which the particle or cell of interest is traveling can be determined using autocorrelation-based velocimetry on the double-exposed image from second camera. This can be a practical approach in situations with high concentrations of particles or cells where over-lapping particles or cells in the image can obscure the blurring effect of the double exposure of the particle or cell of interest. Measuring the time the particle or cell of interest was captured in the image from the first camera, the distance (at the time the image was captured) that the particle or cell was from the region where it would be isolated from the stream, and the speed with which that particle or cell is traveling, can enable the system to determine the precise moment when the particle or cell will be in the region where it can be isolated from the other particles or cells in the stream (e.g., via a liquid jet or bubble jet to deflect particles or cells into a desired collection chamber, or particle or cell sorting using valves). Other methods of moving a particle or cell into a desired collection chamber can be used. In certain aspects, a valve triggering unit can be used to generate triggers for the target particle or cell. A valve trigger unit can actuate a device based on the one or more triggers to send the target particle or target cell to a cell or particle outlet of a microfluidic device. The device used to separate the particle or cell of interest from the sample can be a valve or other mechanical device. Charging plates and/or other pneumatic, piezoelectric, and/or electronic devices can also be used to send target particles or cells to a particle or cell outlet. See, e.g., US Pat. Publ. 20230040252 entitled Label Free Cell Sorting, which is incorporated herein by reference in its entirety. Separation of target particles or cells (sorted to particle or cell outlet) from non-target particles or cells (sorted to another outlet) can also be accomplished using, e.g., a feedback controlled microfluidic piezoelectric valve. See, WO2023205419A1, entitled Feedback Controlled Microfluidic Piezoelectric Valve, which is incorporated herein by reference in its entirety.

In some instances, the system 300 can interact with a computing node 318. The computing node 318 can include a computing instance or series of interconnected computing instances capable of performing processing tasks as described herein. For example, the computing node 318 can cause lasers 314A-B to pulse light at specific exposure times as described herein. Furthermore, the computing node 318 can synchronize an exposure start time and exposure duration across cameras 302A-B.

### Example Design 2

In a second example design, the optical system can include two synchronized cameras and a single multispectral fiber laser operating in pulse mode. The multispectral fiber laser can produce the laser pulses in two separate wavelengths, in a pattern similar as described above.

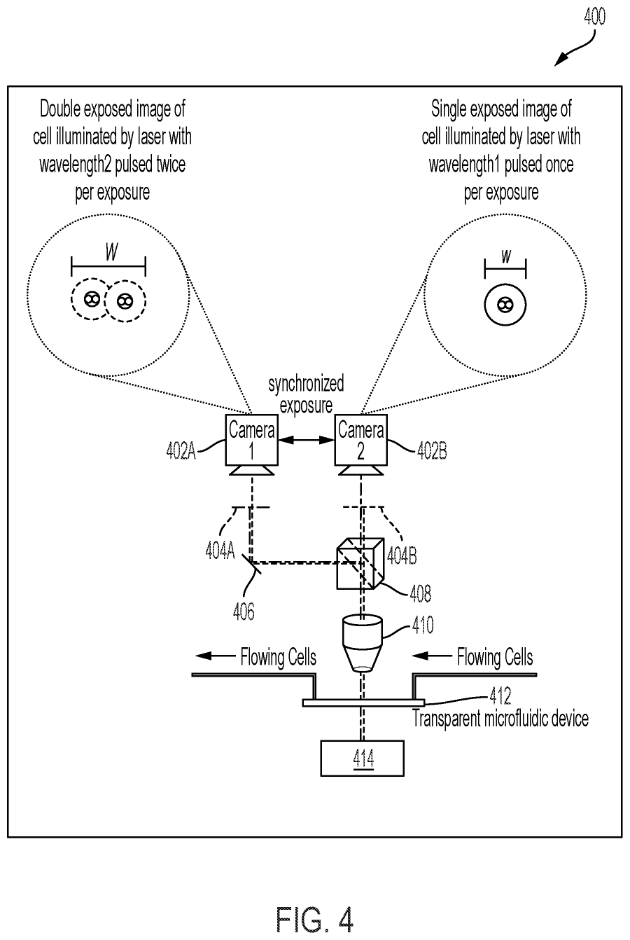

FIG. 4 is an illustration of an example system 400 producing images of particles or cells using light from a multispectral fiber laser pulsing in two wavelengths to measure the speed with which a particle or cell of interest is traversing a microfluidic device. As shown in FIG. 4, the system 400 can include synchronized cameras 402A-B, which can include features similar to cameras 302A-B as described with respect to FIG. 3. In an aspect, the cameras can have synchronized exposure where the two exposures are timed such that each exposure is separated by a short time interval (e.g., about 4 μs to 100 ms (e.g., about 4, 10, 50, 100, 500, 1,000 μs or more or 1, 10, 20, 30, 40, 50, 60, 70, 80, 90, 100 ms or more or any range between about 4 μs and about 100 ms). That is, the two cameras are synchronized, but the first and second exposures can occur sequentially. In an aspect, the first and second exposures can occur at the same time.

Furthermore, optical components including the filters 404A-B, mirror 406, beam splitter 408, and objective 410 can be similar to components as described with respect to FIG. 3.

The multispectral fiber laser 414 can include a laser diode capable of emitting pulses of multiple wavelengths. A laser diode (also called an injection laser diode, semiconductor laser, or diode laser) is a semiconductor device where a diode pumped directly with electrical current can create lasing conditions at the diode's junction. A multispectral fiber laser can include ytterbium-doped fiber lasers, thulium-doped fiber lasers, and erbium-doped fiber lasers. The laser can be pulsed at a set repetition rate to reach high-peak powers (pulsed fiber lasers), as is the case with “q-switched”, “gain-switched” and “mode-locked” lasers.

For example, laser 414 can emit the pulses of light at the first wavelength (e.g., one pulse per exposure) and the second wavelength (e.g., two pulses per exposure) as described herein. The wavelengths can be, e.g., 350, 400, 500, 600, 700, 800 nm or any value between 350 and 800 nm. In some instances, the laser 414 can be disposed below the microfluidic device 412, but, in some cases, the laser 414 can be disposed above the microfluidic device 412 with one or more optical components. Additionally, the cameras, beam splitters, objective, filter, and mirrors can be above or below the microfluidic device.

The relative position of a particle or cell of interest identified within the frame of an image captured by the first camera can be used to identify the corresponding double pulsed particle or cell of interest captured by the second camera. The distance the particle or cell traveled during the interval between pulses of the laser can be calculated from the width of the blurred image of the double pulsed particle or cell less the width of the image of the single exposed particle or cell. Dividing this distance by the time interval between pulses of the second laser can provide the speed the particle or cell is traveling.

The speed of cell can be calculated by:

$$\frac{W - w}{t}$$

Where t is the rate between pulses of laser wavelength W1.

Alternatively, in any frame in which a particle or cell of interest is identified, the speed at which the particle or cell of interest is traveling can be determined using autocorrelation-based velocimetry on the double-exposed image from second camera. This can be a practical approach in situations with high concentrations of particles or cells where over-lapping particles or cells in the image can obscure the blurring effect of the double exposure of the particle or cell of interest. Measuring the time the particle or cell of interest was captured in the image from the first camera, the distance (at the time the image was captured) that the particle or cell was from the region where it would be isolated from the stream, and the speed with which that particle or cell is traveling, can enable the system to determine the precise moment when the particle or cell will be in the region where it can be isolated from the other particles or cells in the stream (e.g., via a liquid jet or bubble jet to deflect particles or cells into a desired collection chamber, or particle or cell sorting using valves). Other methods of moving a particle or cell into a desired collection chamber can be used as described above.

In some instances, the system 400 can interact with a computing node. The computing node can include a computing instance or series of interconnected computing instances capable of performing processing tasks as described herein. For example, the computing node can cause laser 414 to pulse light at specific exposure times as described herein. Furthermore, the computing node can synchronize an exposure start time and exposure duration across cameras 402A-B.

### Example Design 3

In a third example design, an optical system can include a single chromatic camera and a single multispectral fiber laser operating in pulse mode. A chromatic camera can be, for example, a color camera, an RGB camera, a multi-spectral camera, or other suitable camera. The chromatic camera can capture chromatic images of particles or cells of the multiple wavelengths of pulsed light from the multispectral fiber laser. Furthermore, the multispectral fiber laser can produce the laser pulses in two separate wavelengths, in a pattern similar as described above.

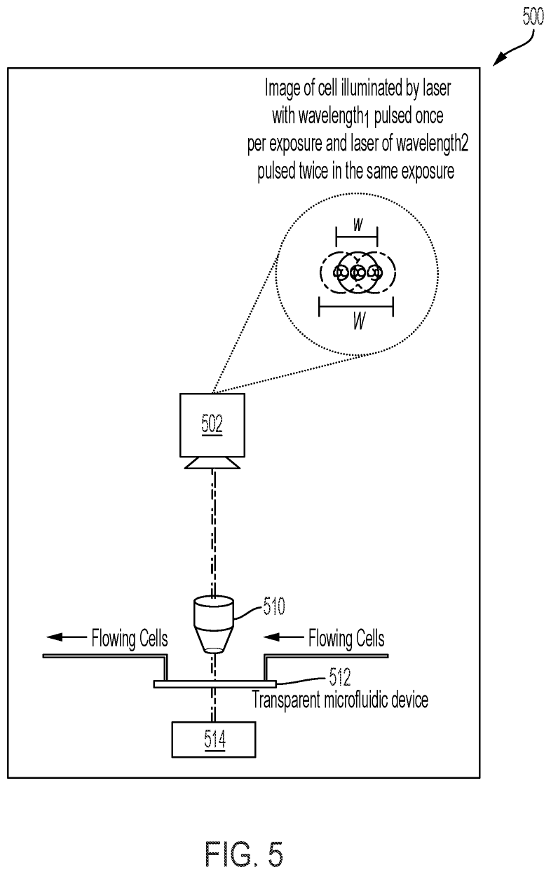

FIG. 5 is an example system 500 producing chromatic images of particles or cells using light from a multispectral fiber laser pulsing in two wavelengths to measure the speed with which a particle or cell of interest is traversing a microfluidic device. As shown in FIG. 5, the system 500 can include a chromatic camera 502, an objective 510, and a multispectral fiber laser operating in pulse mode 514 disposed below the transparent microfluidic device 512.

The single chromatic camera can be used to record holograms generated from two laser pulses of different wavelengths, which can drastically reduce the complexity of the image recording. Holograms can include image patterns generated from the interference between scattered light from the sample and a reference light that has the same frequency as the scattered light (e.g., the laser light generated from the same laser source). The holograms from different color channels (e.g., derived from different wavelengths) can be processed separately for particle- or cell-of-interest detection and speed calculation. For example, a green channel hologram can be used for particle- or cell-of-interest detection and a blue channel hologram can be used for speed calculation.

For example, multispecific fiber laser 514 can emit the pulses of light at the first wavelength (e.g., one pulse per exposure) and the second wavelength (e.g., two pulses per exposure) as described herein. The wavelengths can be, e.g., 350, 400, 500, 600, 700, 800 nm or any value between 350 and 800 nm. In some instances, the multispecific fiber laser 514 can be disposed below the microfluidic device 512, but, in some cases, the laser 514 can be disposed above the microfluidic device 512 with one or more optical components. Additionally, the cameras, beam splitters, objective, filter, and mirrors can be above or below the microfluidic device.

The relative position of a particle or cell of interest identified within the frame of an image captured by the first camera can be used to identify the corresponding double pulsed particle or cell of interest captured by the chromatic camera. The distance the particle or cell traveled during the interval between pulses of the laser can be calculated from the width of the blurred image of the double pulsed particle or cell less the width of the image of the single exposed particle or cell. Dividing this distance by the time interval between pulses of the multispecific fiber laser can provide the speed the particle or cell is traveling.

The speed of cell can be calculated by:

$$\frac{W - w}{t}$$

Where t is the rate between pulses of laser wavelength W1

Alternatively, in any frame in which a particle or cell of interest is identified, the speed at which the particle or cell of interest is traveling can be determined using autocorrelation-based velocimetry on the double-exposed image from the chromatic camera. This can be a practical approach in situations with high concentrations of particles or cells where over-lapping particles or cells in the image can obscure the blurring effect of the double exposure of the particle or cell of interest. Measuring the time the particle or cell of interest was captured in the image from the chromatic camera, the distance (at the time the image was captured) that the particle or cell was from the region where it would be isolated from the stream, and the speed with which that particle or cell is traveling, can enable the system to determine the precise moment when the particle or cell will be in the region where it can be isolated from the other particles or cells in the stream (e.g., via a liquid jet or bubble jet to deflect particles or cells into a desired collection chamber, or particle or cell sorting using valves). Other methods of moving a particle or cell into a desired collection chamber can be used as described above.

In some instances, the system 500 can interact with a computing node. The computing node can include a computing instance or series of interconnected computing instances capable of performing processing tasks as described herein. For example, the computing node can cause multispecific fiber laser 514 to pulse light at specific exposure times as described herein. Furthermore, the computing node can dictate an exposure start time and exposure duration for the chromatic cameras 502.

### Example Design 4

In some instances, the particle or cell concentration in the microfluidic device can be relatively low. In such instances, one camera with double exposures on each recorded frame can be sufficient for both speed calculation and particle or cell identification, provided the fluid flow rate (e.g., about 1, 10, 100, 1,000 μL/min or more or about 1, 2, 5, 7, 10 mL or more, or any range between about 1 μL/min to about 10 mL/min) is such that there is likely no significant overlap between the two exposures of the particle or cell of interest. Therefore, in a fourth example design, a system can include one single wavelength pulse laser or a multispectral pulse laser and a monochromatic camera. The single wavelength pulse laser or multispectral pulse laser can provide a pulse (or two pulses) for each exposure of the monochromatic camera to capture the image of the particle or cell of interest in the microfluidic device channel.

A system can include a monochromatic camera, an objective, and a single wavelength pulse laser or a multispectral pulse laser disposed below the transparent microfluidic device.

The monochromatic camera can be used to record images generated from one or two laser pulses. In some instances, the single wavelength pulse laser or multispectral pulse laser can be disposed below the microfluidic device, but, in some cases, the laser can be disposed above the microfluidic device with one or more optical components. Additionally, the camera, any beam splitters, objective, any filters, and any mirrors can be above or below the microfluidic device.

The distance the particle or cell traveled during the interval between pulses of the laser can be calculated from the width of the blurred image of the double pulsed particle or cell less the width of the image of the single exposed particle or cell. Dividing this distance by the time interval between pulses of the single wavelength pulse laser or a multispectral pulse laser can provide the speed the particle or cell is traveling.

The speed of cell can be calculated by:

$$\frac{W - w}{t}$$

Where t is the rate between pulses of laser wavelength W1. Measuring the time the particle or cell of interest was captured in the image from the monochromatic camera, the distance (at the time the image was captured) that the particle or cell was from the region where it would be isolated from the stream, and the speed with which that particle or cell is traveling, can enable the system to determine the precise moment when the particle or cell will be in the region where it can be isolated from the other particles or cells in the stream (e.g., via a liquid jet or bubble jet to deflect particles or cells into a desired collection chamber, or particle or cell sorting using valves). Other methods of moving a particle or cell into a desired collection chamber can be used as described above.

In some instances, the system can interact with a computing node. The computing node can include a computing instance or series of interconnected computing instances capable of performing processing tasks as described herein. For example, the computing node can cause the single wavelength pulse laser or multispectral pulse laser to pulse light at specific exposure times as described herein. Furthermore, the computing node can dictate an exposure start time and exposure duration for the monochromatic cameras.

### Pulsed Laser Digital Inline Holographic Imaging Systems

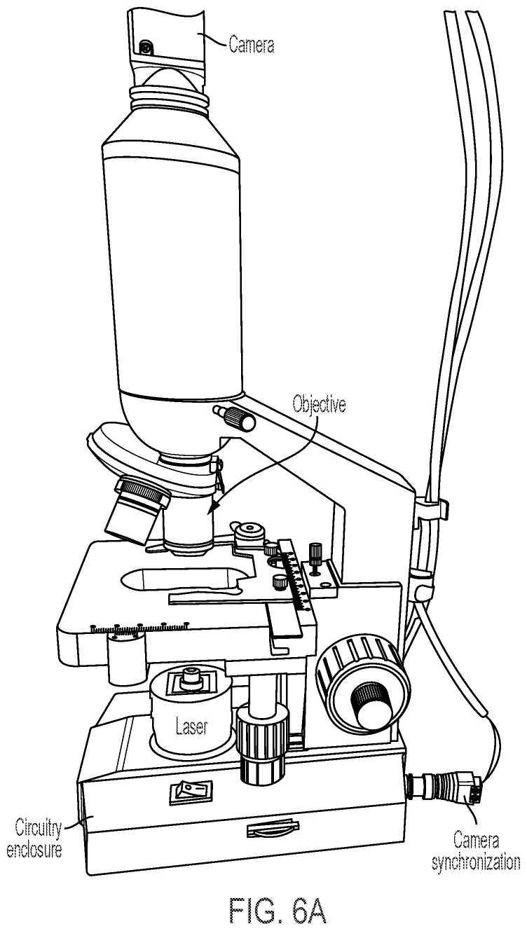

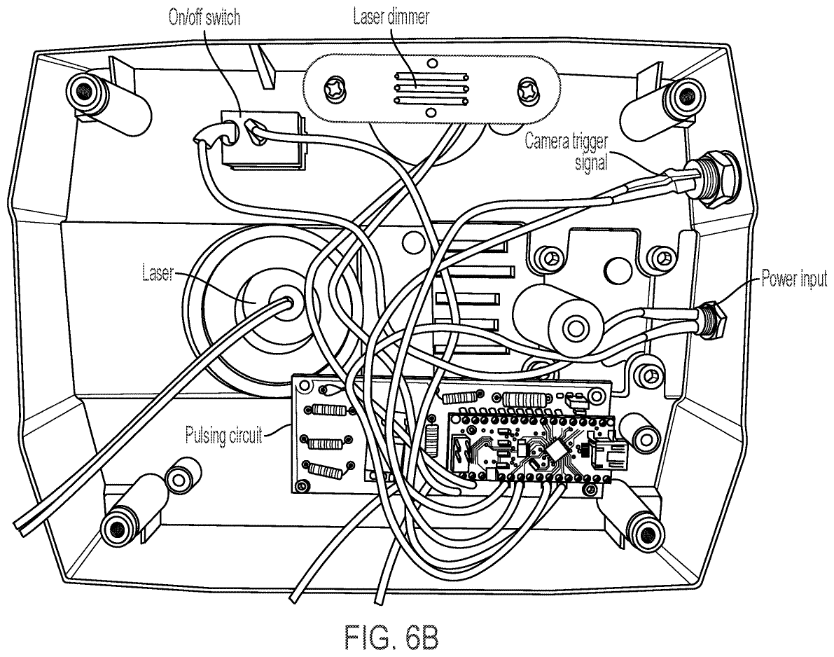

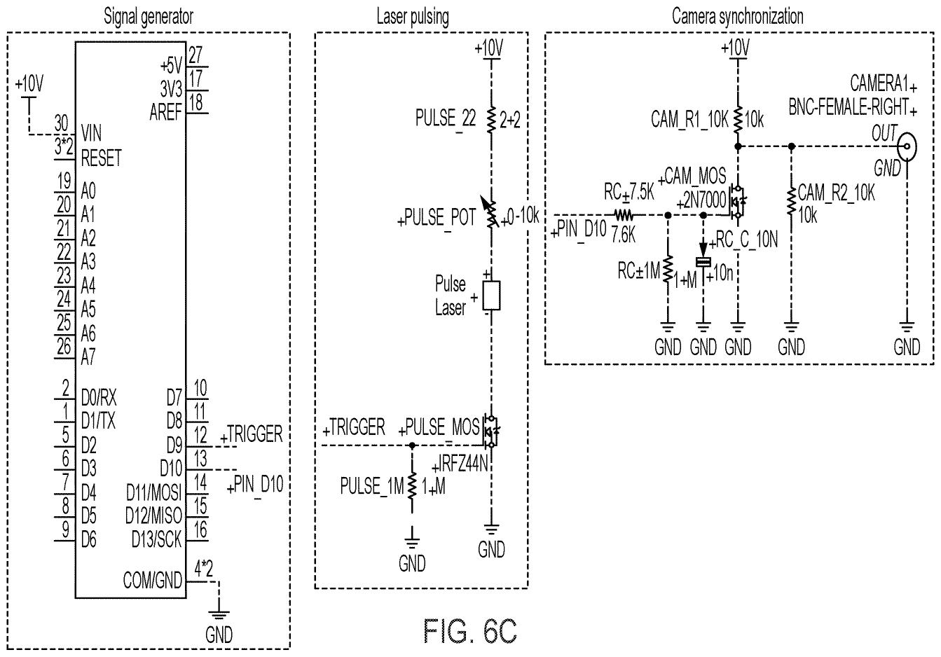

In some embodiments, the optical systems as described herein can be part of a pulsed laser digital inline holographic imaging system for particle or cell sorting. FIGS. 6A-6C illustrate views of a pulsed laser digital inline holographic imaging system for particle or cell sorting. See e.g., WO 2021/155322, which is incorporated herein in its entirety. FIG. 6A shows a pulsed laser digital inline holographic imaging system comprising a camera, an objective, a laser, circuitry enclosure, and a system for camera synchronization. FIG. 6B shows the interior of the circuitry enclosure. The interior can house a laser, an off/on switch, a laser dimmer, a camera trigger signal mechanism, power input, and a pulsing circuit. FIG. 6C shows examples of signal generator, laser pulsing, and camera synchronization circuits.

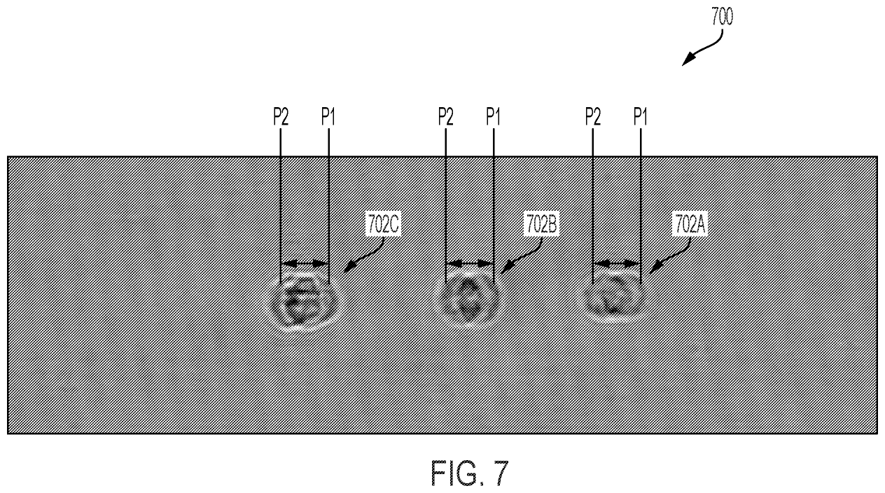

Furthermore, as described above, the camera(s) can capture one or more images of a particle or cell of interest. FIG. 7 is an example double-exposed holographic image 700 showing three cells making small displacement during the time interval between the two exposures. As shown in FIG. 7, the image can capture movement of each cell 702A-C in a microfluidic device. The image 700 can depict a position of the cells 702A-C between exposures of the camera. For example, a distance between a first position P1 and a second position P2 of each cell 702A-C can be used to determine a movement speed of each cell in a microfluidic device.

In an aspect an optical system is provided. The optical system (e.g., 300) can include a first light source (e.g., 314A) configured to emit light of a first wavelength according to a first pulsing pattern. The optical system can also include a second light source (e.g., 314B) configured to emit light of a second wavelength according to a second pulsing pattern. In some aspects the first and second light sources can be replaced by a multispectral fiber laser operating in pulse mode. See, e.g., FIG. 4, 414. In some instances, the first pulsing pattern comprises a single pulse of light of the first wavelength for each exposure duration, and the second pulsing pattern comprises two pulses of light of the first wavelength for each exposure duration, with a first pulse prior to the single pulse of light for the first pulsing pattern and a second pulse after the single pulse of light for the first pulsing pattern.

The optical system can also include a microfluidic device (e.g., 312, 412) configured to transport and isolate a particle or cell (e.g., particle or cell of interest 104) in a fluid (e.g., blood). In some instances, the microfluidic device can include a channel configured to transport the fluid, with a first outlet for isolating particles or cells of a target particle or cell type and a second outlet for outputting any remaining portion of particles or cells in the fluid.

The optical system can also include a first camera (e.g., 302A) configured to capture a first image of the particle or cell in the microfluidic device. The first image can be illuminated by the light of the first wavelength emitted by the first light source. The optical system can also include a second camera (e.g., 302B) configured to capture a second image of the particle or cell in the microfluidic device. The second image can be illuminated by the light of the second wavelength emitted by the second light source. In some instances, the first image comprises a single exposed image of the particle or cell and the second image comprises a double pulsed image of the particle or cell.

The optical system can also comprise a first camera (e.g., 402A) configured to capture a first image of the particle or cell in the microfluidic device. The first image can be illuminated by the light of the first wavelength emitted by a multispectral fiber laser 414. The first camera can also be configured to capture a second image of the particle or cell in the microfluidic device. In some instances, the first image comprises a single exposed image of the particle or cell and the second image comprises a double pulsed image of the particle or cell.

In some instances, the optical system further includes a first filter disposed in front of a lens of the first camera. The first filter can be configured to filter out the light of the second wavelength. The optical system can also include a second filter disposed in front of a lens of the second camera. The second filter can be configured to filter out the light of the first wavelength.

In some instances, the optical system further includes a computing node comprising a memory and a processor. The memory can comprise instructions that, when executed by the processor, cause the processor to perform a series of steps. The steps can include synchronizing, for each of a series of exposures, an exposure time and an exposure duration for each of the first camera and the second camera. The steps can also include causing the first light source and the second light source to emit light according to each of the first pulsing pattern and the second pulsing pattern for each exposure.

In some instances, the instructions further cause the processor to obtain the first image from the first camera and the second image from the second camera and process the first image and the second image to determine whether the particle or cell is of a target particle or cell type, and a speed of the particle or cell traveling in the microfluidic device based on a distance of the particle or cell as depicted in each of two pulses of light of the second wavelength from the second camera according to the second pulsing pattern.

In some instances, the first light source and the second light source are disposed below the microfluidic device, and the first camera and the second camera are disposed above the microfluidic device. In some aspects, a single wavelength pulse laser or a multispectral pulse laser, is disposed below the microfluidic device, and the monochromatic and/or chromatic cameras are disposed above the microfluidic device.

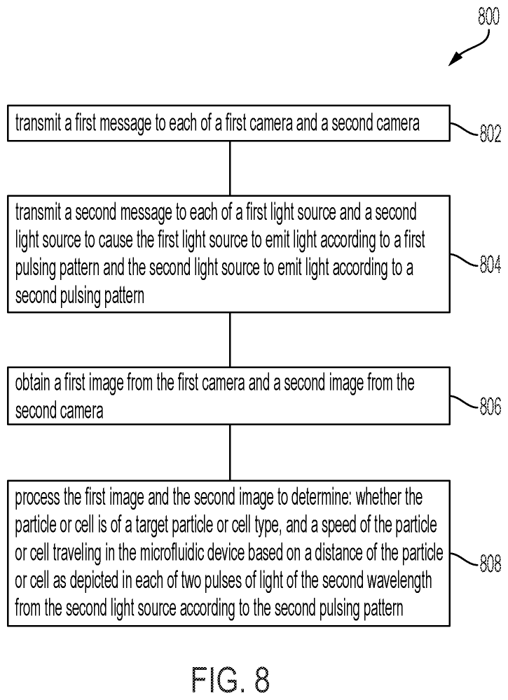

FIG. 8 provides an example method 800 for implementing an optical system managing a throughput of an imaging-based particle or cell sorting system.

At 802, the method can include transmitting, by a computing node, a first message to each of a first camera and a second camera. The first message can include, for each exposure, an exposure start time and exposure duration to capture images of a particle or cell in a microfluidic device.

At 804, the method can also include transmitting, by the computing node, a second message to each of a first light source and a second light source to cause the first light source to emit light according to a first pulsing pattern and the second light source to emit light according to a second pulsing pattern.

At 806, the method can also include obtaining a first image from the first camera and a second image from the second camera. At 808, the method can also include processing the first image and the second image to determine whether the particle or cell is of a target particle or cell type, and a speed of the particle or cell traveling in the microfluidic device based on a distance of the particle or cell as depicted in each of two pulses of light of the second wavelength from the second light source according to the second pulsing pattern.

In some instances, the first pulsing pattern comprises a single pulse of light of the first wavelength for each exposure duration, and wherein the second pulsing pattern comprises two pulses of light of the first wavelength for each exposure duration, with a first pulse prior to the single pulse of light for the first pulsing pattern and a second pulse after the single pulse of light for the first pulsing pattern.

In some instances, the first image comprises a single exposed image of the particle or cell and the second image comprises a double pulsed image of the particle or cell.

In some instances, the microfluidic device comprises a channel configured to transport the fluid, with a first outlet isolating particles or cells of a target particles or cell type and a second outlet outputting any remaining portion of particles or cells in the fluid.

An aspect provides a method of identifying and/or sorting particles comprising delivering a fluid sample comprising the particles to the microfluidic device of an optical system, transmitting a first message to each of the first camera and the second camera, the first message comprising, for each exposure, an exposure start time and exposure duration to capture images of a single particle in the microfluidic device. A second message can be transmitted to each of the first light source and the second light source to cause the first light source to emit light of a first wavelength according to a first pulsing pattern and the second light source to emit light of a second wavelength according to a second pulsing pattern. A first image can be obtained from the first camera and a second image from the second camera. The first image and the second image can be processed to determine whether the single particle is of a target particle type, and a speed of the single particle traveling in the microfluidic device based on a distance of the single particle as depicted in each of two pulses of light of the second wavelength from the second light source according to the second pulsing pattern. The target particle can be a cell, such as a cancerous cell. The microfluidic device can comprise a first outlet for sorting the target particles and a second outlet for outputting non-target particles.

In another example embodiment, a system is provided. The system can include a first camera (e.g., 502) configured to capture a first image of a particle or cell in a microfluidic device. In some aspects, the camera is a chromatic camera or a monochromatic camera.

The system can also include a first light source (e.g., 514) configured to emit at least one light of a first wavelength according to a first pulsing pattern. A first light source can be a single wavelength pulse laser, a multispectral pulse laser, or a multispectral fiber later. In some instances, the first pulsing pattern includes two pulses of light for each exposure of the first camera. In some instances, the first light source is a multi-spectral light source configured to emit light of the first wavelength according to the first pulsing pattern and emit light of a second wavelength according to a second pulsing pattern.

In some instances, the system can also include a second light source configured to emit light of a second wavelength according to a second pulsing pattern. In some instances, the first pulsing pattern comprises a single pulse of light of the first wavelength for each exposure duration, and wherein the second pulsing pattern comprises two pulses of light of the first wavelength for each exposure duration, with a first pulse prior to the single pulse of light for the first pulsing pattern and a second pulse after the single pulse of light for the first pulsing pattern.

The system can also include a microfluidic device (e.g., 512) comprising a channel transporting a fluid containing particles or cells.

In some instances, the system can also include a computing node comprising a memory and a processor, the memory comprising instructions that, when executed by the processor, cause the processor to perform a series of steps. The steps can include synchronizing, for each of a series of exposures, an exposure time and an exposure duration for the first camera. The steps can also include causing the first light source to emit light according to the first pulsing pattern for each exposure. The steps can also include obtaining the image from the first camera. The steps can also include processing the first image a speed of the particle or cell traveling in the microfluidic device based on a distance of the particle or cell as depicted in the first image.

Another aspect provides a method of identifying and/or sorting particles comprising delivering a fluid sample comprising the particles to a microfluidic device of the optical system as described above. A first message can be transmitted to the first camera, the first message comprising, for each exposure, an exposure start time and exposure duration to capture images of a single particle in the microfluidic device. Where two cameras are present a first message can be transmitted to each of the first camera and the second camera. The first message can comprise, for each exposure, an exposure start time and exposure duration to capture images of a single particle in the microfluidic device. A second message can be transmitted to the first light source to cause the first light source to emit light of a first wavelength according to a first pulsing pattern and the first light source to emit light of a second wavelength according to a second pulsing pattern. A first image can be obtained from the first camera and a second image from the first camera. Where two cameras are present, a first image can be obtained from the first camera and a second image from the second camera. The first image and the second image can be processed to determine whether the single particle is of a target particle type, and a speed of the single particle traveling in the microfluidic device based on a distance of the single particle as depicted in each of two pulses of light of the second wavelength from the second light source according to the second pulsing pattern. The cameras can be a chromatic camera or a monochromatic camera. The light sources can be a multispectral fiber laser operating in pulse mode, a single wavelength pulse laser, or a multispectral pulse laser. The target particles can be cells, such as cancerous cells. The microfluidic device can comprise a first outlet for sorting the target particle and a second outlet for outputting non-target particles.

### Computing System Overview

As noted above, the optical systems as described herein can communicate with a computing node (e.g., 318). A computing node can include a computing instance or series of interconnected computing instances capable of performing processing tasks as described herein.

For instance, as described above, the computing node can synchronize exposure start times and exposure durations for each camera (e.g., cameras 302A-B). A message to each camera can specify a time for beginning exposure of a lens of each camera and a total time to expose the lens.

Furthermore, the computing node can instruct one or more light sources to pulse according to specific pulsing patterns (e.g., to around 10% of a camera exposure time, between 1 μs to 10 ms). For example, a message to each light source can indicate, for each exposure, a time for pulsing laser light.

The computing node can obtain an image from each camera and can process the images to determine whether the particle or cell is of a target particle or cell type or to determine a speed of the particle or cell traveling in the microfluidic device. If the speed of a particle or cell is below a threshold, various actions can be taken to increase the speed of the particles or cells traveling in the microfluidic device. Alternatively, if the speed of a particle or cell is above a threshold, various actions can be taken to decrease the speed of the particles or cells traveling in the microfluidic device. In some instances, the action can include the flow rate of a sample stream being adjusted to ensure a particle or cell speed falls to the desired range.

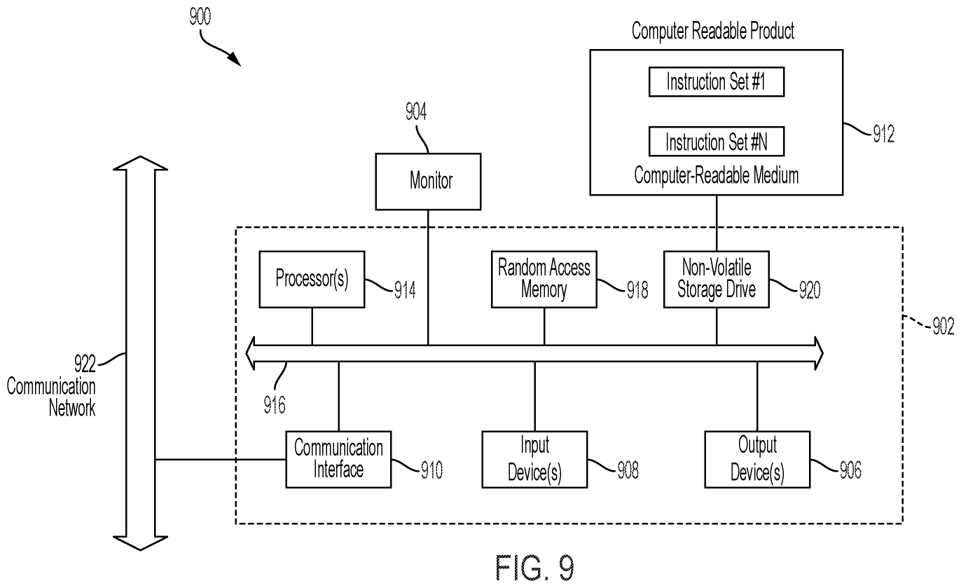

FIG. 9 is a block diagram of a special-purpose computer system 900 according to an embodiment. For example, system 900 can deployed as part of a computing node as described herein. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 900 comprises a computer 902, a monitor 904 coupled to computer 902, one or more additional user output devices 906 (optional) coupled to computer 902, one or more user input devices 908 (e.g., keyboard, mouse, track ball, touch screen) coupled to computer 902, an optional communications interface 910 coupled to computer 902, and a computer-program product including a tangible computer-readable storage medium 912 in or accessible to computer 902. Instructions stored on computer-readable storage medium 912 may direct system 900 to perform the methods and processes described herein. Computer 902 may include one or more processors 914 that communicate with a number of peripheral devices via a bus subsystem 916. These peripheral devices may include user output device(s) 906, user input device(s) 908, communications interface 910, and a storage subsystem, such as random-access memory (RAM) 918 and non-volatile storage drive 920 (e.g., disk drive, optical drive, solid state drive), which are forms of tangible computer-readable memory.

Computer-readable medium 912 may be loaded into random access memory 918, stored in non-volatile storage drive 920, or otherwise accessible to one or more components of computer 902. Each processor 914 may comprise a microprocessor, such as a microprocessor from Intel® or Advanced Micro Devices, Inc.®, or the like. To support computer-readable medium 912, the computer 902 runs an operating system that handles the communications between computer-readable medium 912 and the above-noted components, as well as the communications between the above-noted components in support of the computer-readable medium 912. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 908 include all possible types of devices and mechanisms to input information to computer system 902. These may include a keyboard, a keypad, a mouse, a scanner, a digital drawing pad, a touch screen incorporated into the display, audio input devices such as voice recognition systems, microphones, and other types of input devices. In various embodiments, user input devices 908 are typically embodied as a computer mouse, a trackball, a track pad, a joystick, wireless remote, a drawing tablet, a voice command system. User input devices 908 typically allow a user to select objects, icons, text and the like that appear on the monitor 904 via a command such as a click of a button or the like. User output devices 906 include all possible types of devices and mechanisms to output information from computer 902. These may include a display (e.g., monitor 904), printers, non-visual displays such as audio output devices, etc.

Communications interface 910 provides an interface to other communication networks and devices and may serve as an interface to receive data from and transmit data to other systems, WANs and/or the Internet, via a wired or wireless communication network 922. In addition, communications interface 910 can include an underwater radio for transmitting and receiving data in an underwater network. Embodiments of communications interface 910 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 910 may be coupled to a computer network, to a FireWire® bus, or the like. In other embodiments, communications interface 910 may be physically integrated on the motherboard of computer 902, and/or may be a software program, or the like.

RAM 918 and non-volatile storage drive 920 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 918 and non-volatile storage drive 920 may be configured to store the basic programming and data constructs that provide the functionality of various embodiments of the present invention, as described above.

Software instruction sets that provide the functionality of the present invention may be stored in computer-readable medium 912, RAM 918, and/or non-volatile storage drive 920. These instruction sets or code may be executed by the processor(s) 914. Computer-readable medium 912, RAM 918, and/or non-volatile storage drive 920 may also provide a repository to store data and data structures used in accordance with the present invention. RAM 918 and non-volatile storage drive 920 may include a number of memories including a main random-access memory (RAM) to store instructions and data during program execution and a read-only memory (ROM) in which fixed instructions are stored. RAM 918 and non-volatile storage drive 920 may include a file storage subsystem providing persistent (non-volatile) storage of program and/or data files. RAM 918 and non-volatile storage drive 920 may also include removable storage systems, such as removable flash memory.

Bus subsystem 916 provides a mechanism to allow the various components and subsystems of computer 902 communicate with each other as intended. Although bus subsystem 916 is shown schematically as a single bus, alternative embodiments of the bus subsystem may utilize multiple busses or communication paths within the computer 902.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

The compositions and methods described herein are illustrative only, as numerous modifications and variations therein will be apparent to those skilled in the art. The terms used in the specification generally have their ordinary meanings in the art, within the context of the compositions and methods described herein, and in the specific context where each term is used. Some terms have been more specifically defined herein to provide additional guidance to the practitioner regarding the description of the compositions and methods.

As used herein, the term “and/or” includes any and all combinations of one or more of the associated listed items. As used in the description herein and throughout the claims that follow, the meaning of “a”, “an”, and “the” includes plural reference as well as the singular reference unless the context clearly dictates otherwise. The term “about” in association with a numerical value means that the value varies up or down by 5%. For example, for a value of about 100, means 95 to 105 (or any value between 95 and 105).

All patents, patent applications, and other scientific or technical writings referred to anywhere herein are incorporated by reference herein in their entirety. The embodiments illustratively described herein suitably can be practiced in the absence of any element or elements, limitation or limitations that are specifically or not specifically disclosed herein. Thus, for example, in each instance herein any of the terms “comprising,” “consisting essentially of,” and “consisting of” can be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the claims.

Thus, it should be understood that although the present methods and compositions have been specifically disclosed by embodiments and optional features, modifications and variations of the concepts herein disclosed can be resorted to by those skilled in the art, and that such modifications and variations are considered to be within the scope of the compositions and methods as defined by the description and the appended claims.

Any single term, single element, single phrase, group of terms, group of phrases, or group of elements described herein can each be specifically excluded from the claims.

Whenever a range is given in the specification, for example, a temperature range, a time range, a composition, or concentration range, all intermediate ranges and subranges, as well as all individual values included in the ranges given are intended to be included in the disclosure. It will be understood that any subranges or individual values in a range or subrange that are included in the description herein can be excluded from the aspects herein. It will be understood that any elements or steps that are included in the description herein can be excluded from the claimed compositions or methods.

In addition, where features or aspects of the compositions and methods are described in terms of Markush groups or other grouping of alternatives, those skilled in the art will recognize that the compositions and methods are also thereby described in terms of any individual member or subgroup of members of the Markush group or other group.

What is claimed is:

1. An optical system comprising:
a first light source configured to emit light of a first wavelength according to a first pulsing pattern;
a second light source configured to emit light of a second wavelength according to a second pulsing pattern;
a microfluidic device configured to transport and isolate a single particle in a fluid;
a first camera configured to capture a first image of the single particle in the microfluidic device, wherein the first image is illuminated by the light of the first wavelength emitted by the first light source; and
a second camera configured to capture a second image of the single particle in the microfluidic device, wherein the second image is illuminated by the light of the second wavelength emitted by the second light source.

2. The optical system of claim 1, wherein the first pulsing pattern comprises a single pulse of light of the first wavelength for each exposure duration, and wherein the second pulsing pattern comprises two pulses of light of the second wavelength for each exposure duration.

3. The optical system of claim 2, wherein a first pulse is pulsed prior to the single pulse of light for the first pulsing pattern and a second pulse after the single pulse of light for the first pulsing pattern.

4. The optical system of claim 2, wherein the two pulses of light of the second pulsing pattern occur prior to the single pulse of the first pulsing pattern.

5. The optical system of claim 2, wherein the two pulses of light of the second pulsing pattern occur after the single pulse of the first pulsing pattern.

6. The optical system of claim 2, wherein a first pulse of the second pulsing pattern occurs prior to the single pulse of the first pulsing pattern.

7. The optical system of claim 2, wherein a first pulse of the second pulsing pattern occurs after the single pulse of the first pulsing pattern.

8. The optical system of claim 1, wherein the first image comprises a single exposed image of the single particle and the second image comprises a double pulsed image of the single particle.

9. The optical system of claim 1, further comprising:
a first filter disposed in front of a lens of the first camera, the first filter configured to filter out the light of the second wavelength; and
a second filter disposed in front of a lens of the second camera, the second filter configured to filter out the light of the first wavelength.

10. The optical system of claim 1, wherein the microfluidic device comprises a channel configured to transport the fluid, with a first outlet for isolating single particles of a target particle type and a second outlet for outputting any remaining portion of particles in the fluid.

11. The optical system of claim 1, further comprising:
a computing node comprising a memory and a processor, the memory comprising instructions that, when executed by the processor, cause the processor to:
provide, for each of a series of exposures, an exposure time and an exposure duration for each of the first camera and the second camera; and
cause the first light source and the second light source to emit light according to each of the first pulsing pattern and the second pulsing pattern for each exposure.

12. The optical system of claim 11, wherein the instructions further cause the processor to:
obtain the first image from the first camera and the second image from the second camera; and
processing the first image and the second image to determine whether the single particle is of a target particle type, and a speed of the single particle traveling in the microfluidic device based on a distance of the single particle as depicted in each of two pulses of light of the second wavelength from the second camera according to a timing of the second pulsing pattern.

13. The optical system of claim 1, wherein the first light source and the second light source are disposed below the microfluidic device, and wherein the first camera and the second camera are disposed above the microfluidic device.

14. The optical system of claim 1, wherein the microfluidic device is a sawtooth inertial sorting microfluidic device.

15. The method of claim 12, wherein the speed at which the particle is moving is determined from only one synchronized exposure of the first and second cameras.

16. A method comprising:
transmitting a first message to each of a first camera and a second camera, the first message comprising, for each exposure, an exposure start time and exposure duration to capture images of a single particle in a microfluidic device;
transmitting a second message to each of a first light source and a second light source to cause the first light source to emit light of a first wavelength according to a first pulsing pattern and the second light source to emit light of a second wavelength according to a second pulsing pattern;
obtaining a first image from the first camera and a second image from the second camera; and
processing the first image and the second image to determine whether the single particle is of a target particle type, and a speed of the single particle traveling in the microfluidic device based on a distance of the single particle as depicted in each of two pulses of light of the second wavelength from the second light source according to the second pulsing pattern.

17. The method of claim 16, wherein the first pulsing pattern comprises a single pulse of light of the first wavelength for each exposure duration, and wherein the second pulsing pattern comprises two pulses of light of the first wavelength for each exposure duration, with a first pulse prior to the single pulse of light for the first pulsing pattern and a second pulse after the single pulse of light for the first pulsing pattern.

18. The method of claim 16, wherein the first image comprises a single exposed image of the single particle and the second image comprises a double pulsed image of the single particle.

19. The method of claim 16, wherein the microfluidic device comprises a channel configured to transport a fluid, with a first outlet for isolating particles of a target particle type and a second outlet for outputting any remaining portion of particles in the fluid.

20. The method of claim 16, wherein the microfluidic device is a sawtooth inertial sorting microfluidic device.

21. The method of claim 16, wherein the speed at which the particle is moving is determined from only one synchronized exposure of the first and second cameras.

22. An optical system comprising:
a first camera configured to capture a first image of a single particle in a population of particles in a microfluidic device;
a first light source configured to emit at least one light of a first wavelength according to a first pulsing pattern including at least a first pulse and a second pulse with a timing spaced out such that the single particle is able to be identified and a velocity of the single particle is able to be derived; and
a microfluidic device comprising a channel transporting a fluid containing the single particle.

23. The optical system of claim 22, wherein the first pulsing pattern includes two pulses of light for each exposure of the first camera.

24. The optical system of claim 22, wherein the first light source is a multi-spectral light source configured to emit light of the first wavelength according to the first pulsing pattern and emit light of a second wavelength according to a second pulsing pattern.

25. The optical system of claim 22, further comprising:
a second light source configured to emit light of a second wavelength according to a second pulsing pattern.

26. The optical system of claim 25, wherein the first pulsing pattern comprises a single pulse of light of the first wavelength for each exposure duration, and wherein the second pulsing pattern comprises two pulses of light of the first wavelength for each exposure duration, with a first pulse prior to the single pulse of light for the first pulsing pattern and a second pulse after the single pulse of light for the first pulsing pattern.

27. The optical system of claim 22, wherein the first camera is a monochromatic camera.

28. The optical system of claim 22, wherein the first camera is a chromatic camera.

29. The optical system of claim 22, further comprising: a second camera configured to capture a double pulsed image of the single particle.

30. The optical system of claim 29, wherein the speed at which the particle is moving is determined from only one synchronized exposure of the first and second cameras.

31. The optical system of claim 29, wherein the first and second cameras are chromatic cameras.

32. The optical system of claim 29, further comprising:
a first filter disposed in front of a lens of the first camera, the first filter configured to filter out the light of a second wavelength; and
a second filter disposed in front of a lens of the second camera, the second filter configured to filter out the light of the first wavelength.

33. The optical system of claim 22, further comprising:
a computing node comprising a memory and a processor, the memory comprising instructions that, when executed by the processor, cause the processor to:
synchronize, for each of a series of exposures, an exposure time and an exposure duration for the first camera; and
cause the first light source to emit light according to the first pulsing pattern for each exposure.
obtain the image from the first camera; and
process the first image a speed of the single particle traveling in the microfluidic device based on a distance of the single particle as depicted in the first image.

34. The optical system of claim 22, wherein the microfluidic device is a sawtooth inertial sorting microfluidic device.

35. A method of identifying and/or sorting particles comprising delivering a fluid sample comprising the particles to the microfluidic device of the optical system of claim 1, transmitting a first message to each of the first camera and the second camera, the first message comprising, for each exposure, an exposure start time and exposure duration to capture images of a single particle in the microfluidic device;
transmitting a second message to each of the first light source and the second light source to cause the first light source to emit light of a first wavelength according to a first pulsing pattern and the second light source to emit light of a second wavelength according to a second pulsing pattern;
obtaining a first image from the first camera and a second image from the second camera; and
processing the first image and the second image to determine whether the single particle is of a target particle type, and a speed of the single particle traveling in the microfluidic device based on a distance of the single particle as depicted in each of two pulses of light of the second wavelength from the second light source according to the second pulsing pattern.

36. The method of claim 35, wherein the target particle is a cell.

37. The method of claim 36, wherein the target particle is a cancerous cell.

38. The method of claim 35, wherein the microfluidic device comprises a first outlet for sorting the target particle and a second outlet for outputting non-target particles.

39. A method of identifying and/or sorting particles comprising delivering a fluid sample comprising the particles to the microfluidic device of the optical system of claim 29, transmitting a first message to each of the first camera and the second camera, the first message comprising, for each exposure, an exposure start time and exposure duration to capture images of a single particle in the microfluidic device;
transmitting a second message to the first light source to cause the first light source to emit light of a first wavelength according to a first pulsing pattern and the first light source to emit light of a second wavelength according to a second pulsing pattern;
obtaining a first image from the first camera and a second image from the second camera; and
processing the first image and the second image to determine whether the single particle is of a target particle type, and a speed of the single particle traveling in the microfluidic device based on a distance of the single particle as depicted in each of two pulses of light of the second wavelength from the second light source according to the second pulsing pattern.

40. The method of claim 39, wherein the first light source is a multispectral fiber laser operating in pulse mode.

35. The method of claim 39, wherein the target particle is a cell.

36. The method of claim 35, wherein the target particle is a cancerous cell or an immune cell.

37. The method of claim 39, wherein the microfluidic device comprises a first outlet for sorting the target particle and a second outlet for outputting non-target particles.

38. A method of identifying and/or sorting particles comprising delivering a fluid sample comprising the particles to the microfluidic device of the optical system of claim 22, transmitting a first message to the first camera, the first message comprising, for each exposure, an exposure start time and exposure duration to capture images of a single particle in the microfluidic device;
transmitting a second message to the first light source to cause the first light source to emit light of a first wavelength according to a first pulsing pattern and the first light source to emit light of a second wavelength according to a second pulsing pattern;
obtaining a first image from the first camera and a second image from the first camera; and
processing the first image and the second image to determine whether the single particle is of a target particle type, and a speed of the single particle traveling in the microfluidic device based on a distance of the single particle as depicted in each of two pulses of light of the second wavelength from the second light source according to the second pulsing pattern.

39. The method of claim 38, wherein the first camera is a chromatic camera.

40. The method of claim 38, wherein the first camera is a monochromatic camera.

41. The method of claim 38, wherein the first light source is a multispectral fiber laser operating in pulse mode.

42. The method of claim 38, wherein the first light source is a single wavelength or multispectral pulse laser.

43. The method of claim 38, wherein the target particle is a cell.

44. The method of claim 43, wherein the target particle is a cancerous cell or an immune cell.

45. The method of claim 38, wherein the microfluidic device comprises a first outlet for sorting the target particle and a second outlet for outputting non-target particles.
